(19) United States
(12) Patent Application Publication
(10) Pub. No.: US 2015/0160072 A1
(43) Pub. Date: Jun. 11, 2015

(54) ORIENTED BACKSCATTERING WIDE DYNAMIC-RANGE OPTICAL RADIATION SENSOR

(71) Applicant: Rensselaer Polytechnic Institute, Troy, MI (US)

(72) Inventors: Xing Yan, Ames, IA (US); Michael Shur, Latham, NY (US)

(21) Appl. No.: 14/561,398

(22) Filed: Dec. 5, 2014

Related U.S. Application Data
(60) Provisional application No. 61/912,598, filed on Dec. 6, 2013.

(51) Int. Cl. G01J 1/42; G01M 11/02; G01M 11/00

(52) U.S. Cl. CPC G01J 1/4257; G01M 11/005; G01M 11/0207

(57) ABSTRACT

A system for monitoring and controlling optical energy. A system is disclosed having: an optical system with a surface for receiving an optical beam; a coating applied to the surface, wherein the coating includes an optical nanoporous dielectric thin film having an array of tilted nanoscale rods configured to reflect a scatter beam at a determined angle and pass a remaining portion of the optical beam to the surface; a satellite detector arranged to detect an intensity of the scatter beam; and a control system that receives and processes scatter beam data from the satellite detector to determine an intensity of the optical beam impacting the surface of the optical system.

### PRIORITY CLAIM

This application claims priority to co-pending provisional application, “Oriented backscattering wide dynamic-range optical radiation sensor and the application there of,” Ser. No. 61/912,598, filed on Dec. 6, 2013, the contents of which are hereby incorporated by reference.

### BACKGROUND

1. Technical Field

The present invention relates generally to material coatings for optical devices, and more particularly to a coating that provides anti-reflection properties while deflecting a controlled fraction of light flux for monitoring and control purposes.

2. Related Art

There exist any number of high performance optical materials, e.g., solar cells, sensors, lenses, glass, mirrors, etc., that have surfaces that manipulate or exploit optical radiation, such as ultraviolet (UV) or light energy. For example, a solar cell has a surface made from a semiconducting material such as silicon that converts light energy into electricity. In a further example, sensors such as photo resistors output a resistance value based on an amount of light energy incident upon the sensor surface. In yet another example, glass lenses utilize refraction to focus light beams.

One of the challenges with such materials involves the ability to accurately measure the beam intensity impacting the material surface. The need for measuring intensity can be important in various applications, e.g., dirt or other contaminants can limit the amount of light entering the material, which reduces the efficacy or impacts the operation of the device. Current approaches for measuring light on an optical surface often involve the use of beam splitters and/or optical attenuators. Unfortunately, devices such as those employing optical attenuators must absorb a significant amount of energy, which adversely impacts the device used to perform the evaluation. Such devices often convert optical energy to heat energy, thereby damaging the attenuator material.

### SUMMARY OF THE INVENTION

Disclosed herein is a novel type of coating that combines unique optical properties, such as serving as an antireflection coating with the ability to deflect a controlled fraction of the light flux for monitoring and control.

In a first aspect, the invention provides a system for monitoring and controlling optical energy, comprising: an optical system having a surface for receiving an optical beam; a coating applied to the surface, wherein the coating includes an optical nanoporous dielectric thin film having an array of tilted nanoscale rods configured to reflect a scatter beam at a determined angle and pass a remaining portion of the optical beam to the surface; a satellite detector arranged to detect an intensity of the scatter beam; and a control system that receives and processes scatter beam data from the satellite detector to determine an intensity of the optical beam impacting the surface.

In a second aspect, the invention provides a method for monitoring and controlling optical energy, comprising: providing an optical system having a surface; providing a coating applied to the surface, wherein the coating includes an optical nanoporous dielectric thin film having an array of tilted nanoscale rods; receiving an optical beam directed at the coating; reflecting a scatter beam at a determined angle and passing a remaining portion of the optical beam to the surface; detecting an intensity of the scatter beam at a satellite detector; and processing scatter beam data from the satellite detector to calculate an intensity of the optical beam impacting the surface.

In a third aspect, the invention provides an attenuation system, comprising: an optical system having a surface for receiving an optical beam; and a coating applied to the surface, wherein the coating includes an optical nanoporous dielectric thin film having an array of tilted nanoscale rods configured to reflect a scatter beam at a determined angle and pass an attenuated portion of the optical beam to the optical system.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a monitoring system in accordance with embodiments of the invention.

FIG. 2 depicts an image of a nanoporous dielectric thin film material having tilted nanoscale rods in accordance with embodiments of the invention.

FIG. 3 depicts an image of a two layer nanoporous dielectric thin film material having tilted nanoscale rods in accordance with embodiments of the invention.

FIG. 4 depicts experimental and simulated results showing peak intensity for the material of FIG. 2.

FIG. 5 depicts a table showing peak intensity positions for nanorods at different tilt angles.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

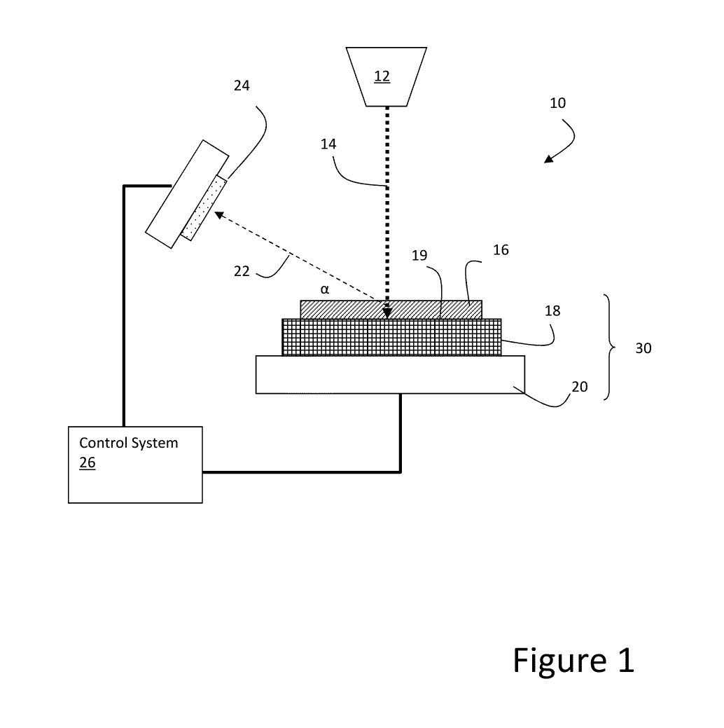

Referring to FIG. 1, a monitoring and control system 10 is shown that generally includes an optical energy receiver 18 having a scattering medium 16 applied to its surface 19. Optical energy receiver 18 may comprise any type of optical material that receives, manipulates or exploits optical energy, e.g., a solar cell, a sensor, a detector, a lens, glass, a mirror, etc. Optical energy receiver 18 may optionally be implemented with a device 20 that for example, outputs electricity, heat energy, a control signal, etc., to a control system 26. The combination of the scattering medium 16, optical energy receiver 18 and/or device 20 is generally referred to herein as an optical system 30. Also included in monitoring and control system 10 is a satellite detector 24 for detecting a deflected flux or scatter beam 22 that is indicative of the amount of radiation of a main beam 14 incident upon the surface 19 of optical energy receiver 18. Main beam 14 may originate from any source 12 and comprise any type of optical energy, including the sun, ambient lighting, reflective lighting, manmade lighting, LED lighting, etc.

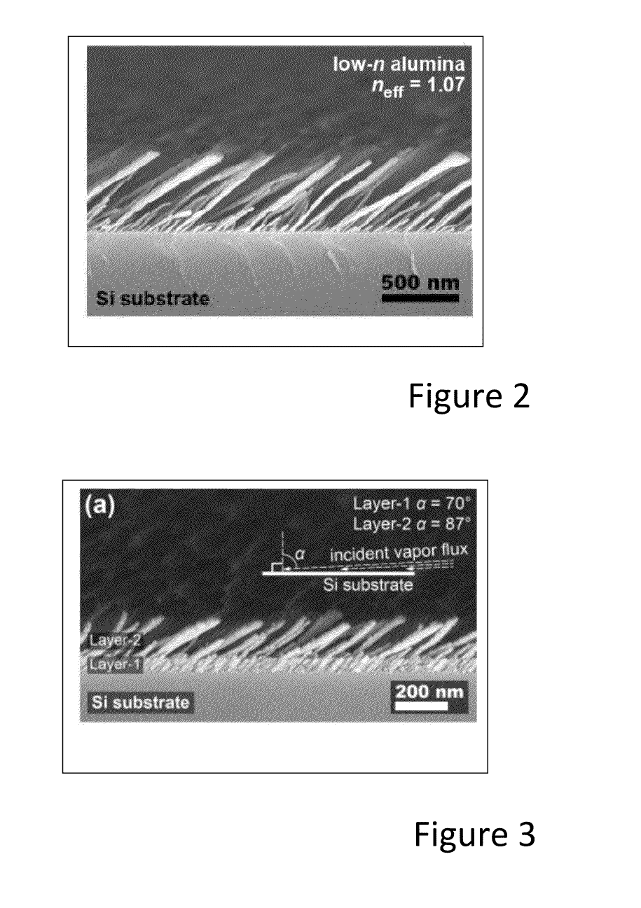

Scattering medium 16 employs an optical nanoporous dielectric thin film material (i.e., coating) comprising an array of highly tuned tilted nanoscale rods, such as that shown in FIGS. 2 and 3. The scattering medium 16 provides a non-absorbing beam manipulation that is controlled by the material composition, and the unique nanoscale structure of the nanoscale thin film coating. By choosing material species with zero absorption at a particular wavelength band, while maintaining the unique highly ordered internal structure of nanoscale thin film coating, beam manipulation that is virtually free of absorption is realized. The nanoporosity, refractive index, and thickness of the nanoscale thin film coating can be tailored to meet the design specifications of receivers 18 with different dynamic ranges.

The fabrication process of the nanoporous dielectric thin film materials is purely additive and compatible with state-of-the-art optical energy detectors. For example, tilted low-n Alumina nanorods fabricated by glancing angle deposition may be utilized. Oblique-angle deposition, also known as glancing angle deposition (GLAD), is a general thin film deposition method for depositing nano-scale porous materials. Being a physical deposition process, oblique-angle deposition utilizes surface-diffusion and self-shadowing effects to form nanometer size rods on a specular substrate surface. Such a deposition process is known to be applied to a variety of optical thin film materials. Tailored- and low-refractive index thin film materials, fabricated by glancing angle deposition, may include a widely tunable refractive index, and have compatibility with a variety of bulk material species, and can thus be readily applied for fabricating multilayer structures.

Several layers of a coating can therefore be used, including using a periodic multilayer design to enhance the scatter beam 22. A multilayer scattering medium 16 arranged with a designed separation can form constructive interference such that the detection peak of the scatter beam 22 can be narrowed in angular width and enhanced in intensity. The implementation can be optimized using a genetic algorithm.

FIGS. 2 and 3 show cross-sectional-views scanning electron microscopy (SEM) images of a one and the two-layer alumina ARC on a Si reference sample, respectively. As shown in FIG. 3, the deposition angle α is defined as the angle between the Si substrate normal and the direction of incident alumina vapor flux. In this example, the deposition rate of Layer-1 and Layer-2 were maintained at 0.15-0.2 nm·s−1 during e-beam evaporation.

Once implemented, the disclosed system 10 can perform real-time sensing of the optical energy of the scatter beam 22, while the main beam 14 is transmitted through to the surface 19 of the optical energy receiver 18 for a primary application. No extra beam splitter is required to bend the beam 14 for detection. The satellite detector 24 can capture and determine an intensity of the scatter beam 22, which is proportional to the intensity of the main beam 14. Because the scattering medium 16 is non-absorbing, it does not interfere with the operation of the optical energy receiver 18. Further, because the energy in the scatter beam 22 is significantly lower than the main beam 14 (e.g., three or so orders of magnitude less), satellite detector 24 may be implemented with a relatively high intensity detector relative to detector used by optical energy receiver 18.

Scattering medium 16 also allows for a greater dynamic range, beyond the 60-70 dB of current sensors. A multistage design for example could provide a dynamic range similar to that of the human eye, e.g., 140-200 dB.

In a further embodiment, scattering medium 16 comprising a multilayered nanoporous dielectric thin film may be employed as a beam attenuator. Since the attenuation of an optical energy beam relies on non-absorbing scattering, the disclosed type of beam attenuator does not suffer from attenuator damage due to high optical density. An optical energy attenuator using scattering medium 16 is based on scattering. Therefore, no energy or heat accumulates in the scattering medium 16.

In the embodiment shown in FIG. 1, the satellite detector 24 can be utilized as part of a feedback loop in which a measured amount of intensity of scatter beam 22 is fed back to and utilized by control system 26 to make system level adjustments. For example, if the optical system 30 provided a sensor that outputs a signal based on a detected amount of incident radiation from main beam 14, the optical system 30 could be adjusted or biased based on the amount of scatter beam 22 detected by satellite detector 24 over time. Accordingly, as changing conditions impact the optical energy receiver 18, the sensitivity or performance of the optical system 30 could be adjusted.

In another example, solar cells with an antireflection coating using scattering medium 16 could be provided along with satellite detector 24 to monitor surface contamination via control system 26 and indicate when the surface must be cleaned to maintain the solar cell efficiency. Such a coating could be used for any system controlling contamination or for cleaning displays, such as displays in systems such as Google Glass, or even more conventional glasses, sunglasses, outdoor displays, windows, etc. Possible applications also include highly sensitive, high speed, wide dynamic range optical energy sensors used for smart lighting, medical imaging, machine automation, and surveillance.

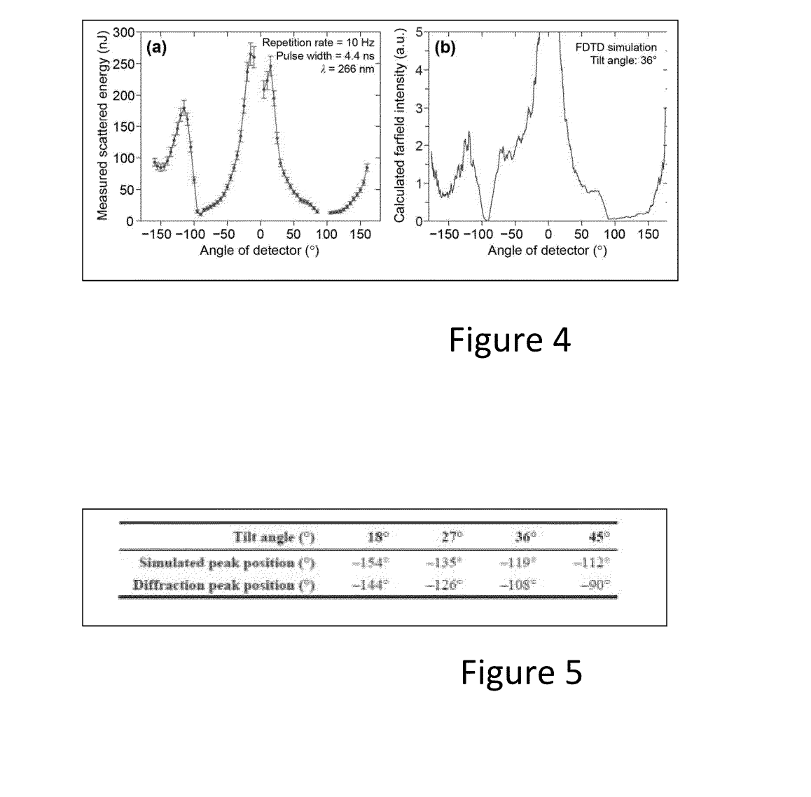

As noted, scattering medium 16 includes an array of obliquely aligned nanorods that provide asymmetric backscattering, i.e., medium 16 will generate a scatter beam 22 when a main beam 14 is received, without absorbing any of the energy. The behavior of the scatter beam 22 relative to the main beam 14 can be readily determined based on the design of the scattering medium 16. For instance, in the illustrative example shown in FIG. 2, the scattering medium comprises nanoporous alumina with a layer thickness of 550 nm. The effective refractive index (neff) of the nanoporous alumina layer is neff=1.07 at λ=410 nm. The depicted alumina nanorod array is arranged to have tilt angle of 126° (36° with respect to the substrate plane). Based on simulation and/or experimentation, it is possible to ascertain the angle at which peak intensity of the scatter beam will occur. For example, as shown in FIG. 4, a measured (left side) and simulated (right side) scattering distribution is shown for the scattering medium of FIG. 2. In this example, the simulated reflectance peak occurred at −119°, which is in excellent agreement with the measured scattering intensity peak of −115°. FIG. 5 further illustrates simulated scattering peak position and diffraction peak position of tilted alumina nanorod arrays with tilt angles of 18°, 27°, 36°, and 45°. With a satellite detector 24 positioned at the appropriate angular position, a proportionality factor between the main beam intensity and the scatter beam intensity can be readily ascertained.

Given the predictable behavior of the nanorods arrays, scattering medium 16 and satellite detector 24 can thus be designed, implemented, and tuned to predictably deflect and capture a proportional amount of the main beam 14 at a determined angle α relative to the surface 19 of the optical energy receiver 18. It is understood that any number of factors may impact the overall design and function of monitoring and control system 10, including thickness and properties of the scattering medium 16, tilt angle of the nanorods, placement of the satellite detector 24, etc.

As shown FIG. 1, control system 26 may for example comprise a computing system having a processor, programmed memory and input/output that can read in scatter beam data from the satellite detector 24, process the scatter beam data based on a predetermined proportionality factor, and output a result based on or proportional with with an intensity of the main beam 14. For example, it might be determined that the scatter beam 22 has an intensity that is a multiple of 0.0025 relative the main beam 14 (i.e., a proportionality factor of 0.0025). Accordingly, once the scatter beam 22 is read by the satellite sensor 24, the main beam intensity can be determined and outputted by control system 26 in real-time. For example, the main beam intensity (MB) may be calculated as MB=SB/(0.0025), where SB is the scatter beam intensity. Control system 26 may also be implemented as purely hardware, e.g., a circuit, or a combination of hardware and embedded software.

Control system 26 may utilize the scatter beam data for any purpose. For example, control system 26 could utilize the data: to calibrate the proportionality factor between the main beam and the scattered beam, e.g., at a weak input signal; to frequency lock the scatter signal 22 to the main beam signal 14 for weak signal measurement; for measuring the light absorption in the device structure by comparing the scattered and transmitted (main beam) signals, etc.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A system for monitoring and controlling optical energy, comprising:
an optical system having a surface for receiving an optical beam;
a coating applied to the surface, wherein the coating includes an optical nanoporous dielectric thin film having an array of tilted nanoscale rods configured to reflect a scatter beam at a determined angle and pass a remaining portion of the optical beam to the surface;
a satellite detector arranged to detect an intensity of the scatter beam; and
a control system that receives and processes scatter beam data from the satellite detector to determine an intensity of the optical beam impacting the surface of the optical system.

2. The system of claim 1, wherein the optical system is selected from a group consisting of: a solar cell, a sensor, a lens, a glass, and a mirror.

3. The system of claim 1, wherein the intensity of the optical beam is determined based on an intensity of the scatter beam and predetermined proportionality factor.

4. The system of claim 1, wherein the determined angle of the scatter beam is determined based on an angle of the tilted nanorods.

5. The system of claim 1, wherein the intensity of the scatter beam is approximately three orders of magnitude less than the intensity of the optical beam impacting the surface.

6. The system of claim 1, wherein the optical system is implemented with a device that outputs at least one of: electricity, heat energy, and a control signal.

7. The system of claim 6, wherein the control system includes an output for controlling the device.

8. A method for monitoring and controlling optical energy, comprising:
providing an optical system having a surface;
providing a coating applied to the surface, wherein the coating includes an optical nanoporous dielectric thin film having an array of tilted nanoscale rods;
receiving an optical beam directed at the coating;
reflecting a scatter beam at a determined angle and passing a remaining portion of the optical beam to the surface;
detecting an intensity of the scatter beam at satellite detector; and
processing scatter beam data from the satellite detector to calculate an intensity of the optical beam impacting the surface of the optical system.

9. The method of claim 8, wherein the optical system is selected from a group consisting of: a solar cell, a sensor, a lens, glass, and a mirror.

10. The method of claim 8, wherein the intensity of the optical beam is determined based on an intensity of the scatter beam and predetermined proportionality factor.

11. The method of claim 8, wherein the determined angle of the scatter beam is determined based on an angle of the tilted nanorods.

12. The method of claim 8, wherein the intensity of the scatter beam is approximately three orders of magnitude less than the intensity of the optical beam impacting the surface.

13. The method of claim 8, wherein the optical system is implemented with a device that outputs at least one of: electricity, heat energy, and a control signal.

14. The method of claim 13, further comprising: utilizing a calculated intensity of the optical beam to control the device.

15. An attenuation system, comprising:
an optical system having a surface for receiving an optical beam; and
a coating applied to the surface, wherein the coating includes an optical nanoporous dielectric thin film having an array of tilted nanoscale rods configured to reflect a scatter beam at a determined angle and pass an attenuated portion of the optical beam to the surface of the optical system.

16. The attenuation system of claim 15, further comprising:
a satellite detector arranged to detect an intensity of the scatter beam; and
a control system that receives and processes scatter beam data from the satellite detector to determine an amount of attenuation caused by the coating on the optical beam.

17. The attenuation system of claim 15, wherein the amount of attenuation is determined from the intensity of the scatter beam and a proportionality factor.

18. The attenuation system of claim 15, wherein the optical system is selected from a group consisting of: a solar cell, a sensor, a lens, glass, and a mirror.

19. The attenuation system of claim 15, wherein the optical system is implemented with a device that outputs at least one of: electricity, heat energy, and a control signal.

20. The attenuation system of claim 19, wherein the control system utilizes a calculated intensity of the optical beam to control the device.
